(19) United States
(12) Patent Application Publication
(10) Pub. No.: US 2002/0121138 A1
(43) Pub. Date: Sep. 5, 2002

(54) Device for determining the filling level of a filling material in a container

(75) Inventor: Thomas Malzahn, Rheine (DE)

Correspondence Address: Felix J. D'Ambrosio, JONES, TULLAR & COOPER, P.C., Eads Station, P.O. Box 2266, Arlington, VA, 22202, US

(73) Assignee: Endress + Hauser GmbH + Co.

(21) Appl. No.: 09/901,647

(22) Filed: Jul. 11, 2001

(30) Foreign Application Priority Data
Mar. 3, 2001 (DE) 101 10 230.5

(51) Int. Cl. G01F 23/00

(52) U.S. Cl. 73/290 R

(57) ABSTRACT

The device according to the present invention serves the purpose of determining the filling level of a filling material in a container. It has the following components: a signal-generating unit which generates measuring signals, a signal injector and at least one antenna having an antenna, the signal injector injecting the measuring signals onto the antenna structure. The antenna emits the measuring signals in the direction of the surface of the filling material, and an evaluation circuit which receives the measuring signals reflected at the surface of the filling material and received by the antenna determines the filling level in the container via the propagation time of the measuring signals. The antenna has at least one first dielectric substrate to which the antenna structure is applied. The antenna structure is at least one spiral antenna.

### FIELD OF THE INVENTION

The present invention relates to a device for determining the filling level of a filling material in a container.

### BACKGROUND OF THE INVENTION

In filling level measuring instruments which operate in a contactless fashion and with radio-frequency measuring signals, planar antennas are also used in addition to horn, rod and parabolic antennas. Configurations of planar antennas are described, for example, in the book “Einführung in die Theorie und Technik planarer Mikrowellenantennen in Mikrostreifenleitungstechnik” [“Introduction to the Theory and Technology of Planar Microwave Antennas in Microstrip Line Technology”] by Gregor Gronau, Verlagsbuchhandlung Nellissen-Wolff or in the journal article “Impedance of a radiating slot in the ground plane of a microstrip line”, IEEE Trans. Antennas Propagat., Vol. AP-30, 922-926, May 1982.

Known planar antennas usually comprise a dielectric substrate on one side of which the antenna structure is provided, and on the other side of which a conductive coating with cutouts is provided. An asymmetric stripline is, moreover, the basis of the most widespread planar antenna structure.

By contrast with other types of antenna, planar antennas are distinguished as regards the filling level measuring technique by a short block distance. Block distances are understood as the proximity zone of the antenna, in which the unwanted emission is so large that the actual useful echo signal which characterizes the filling level, can no longer be detected. The unwanted emission is essentially caused by reflections of the measuring signals during transition from one material/medium with a first dielectric coefficient into a material/medium with a second dielectric coefficient. Consequently, the filling level can be determined correctly only as long as the surface of the filing level comes to lie below the block distance. The block distance, which can certainly be of the order of magnitude of a meter, very substantially limits the measuring range of an antenna. This is, of course, more disturbing the smaller the container dimensions.

Although planar antennas have a relatively small block distance by comparison, for example, with a rod antenna, they have a not inconsiderable disadvantage: so-called “ringing” arises during emission of broadband measuring signals, that is to say radio-frequency pulses. The term “ringing” in turn masks interference signals which present reliable determination of the filling level in the proximity zone of the antenna. Thus, known patch antennas have impedance widths of approximately 10% for a standing wave ratio VSWR of less than 1:2. This naturally puts the possible uses of conventional planar antennas into perspective.

### SUMMARY OF THE INVENTION

It is the object of the present invention to provide a filling level measuring device which also delivers reliable measurement results in the proximity zone of the antenna.

This object is achieved by a device which comprises the following components: a signal-generating unit which generates measuring signals, a signal injector and at least one antenna having an antenna structure, the signal injector injecting the measuring signals onto the antenna structure, the antenna emitting the measuring signals in the direction of the surface of the filling material, and an evaluation circuit which uses the propagation time of the measuring signals between the antenna and surface of the filling material to determine the filling level in the container. Moreover, the antenna has at least one first dielectric substrate to which the antenna structure is applied. The antenna structure is at least one spiral antenna.

In accordance with an advantageous development of the device according to the present invention, the measuring signals are measuring pulses or FMCW signals. These are the two known types of measuring signals which can be used in determining the distance of an object—here the surface of the filling material—by measuring the propagation time of electromagnetic measuring signals.

In accordance with a preferred refinement of the device according to the present invention, the antenna structure is at least one logarithmic spiral antenna. In particular, the dimensions of the at least one spiral antenna or the logarithmic spiral antenna are coordinated such that measuring signals of a desired frequency range can be emitted and/or received.

It is viewed as particularly advantageous in this case that the frequency range of the emitted and/or the received measuring signals is determined substantially by the inside diameter, the outside diameter and/or the number of the turns of the spiral antenna.

In accordance with a preferred development of the device according to the present invention, the spiral antenna has a first spiral arm and a second spiral arm. This renders it possible to use one and the same antenna to radiate measuring signals in two different frequency ranges. For example, measuring signals of 6 GHz and 24 GHz can be radiated and received via a two-arm spiral antenna.

The spiral antenna or the spiral antennas is/are applied to the dielectric substrate using stripline technology. The antenna structure usually consists of copper.

### BRIEF DESCRIPTION OF THE DRAWINGS

The present invention is explained in more detail with the aid of the following drawings, in which:

FIG. 1 shows a schematic of the device according to the present invention, and

FIG. 2 shows a plan view of the antenna structure according to the present invention, which is used in a filling level measuring instrument.

### DETAILED DESCRIPTION

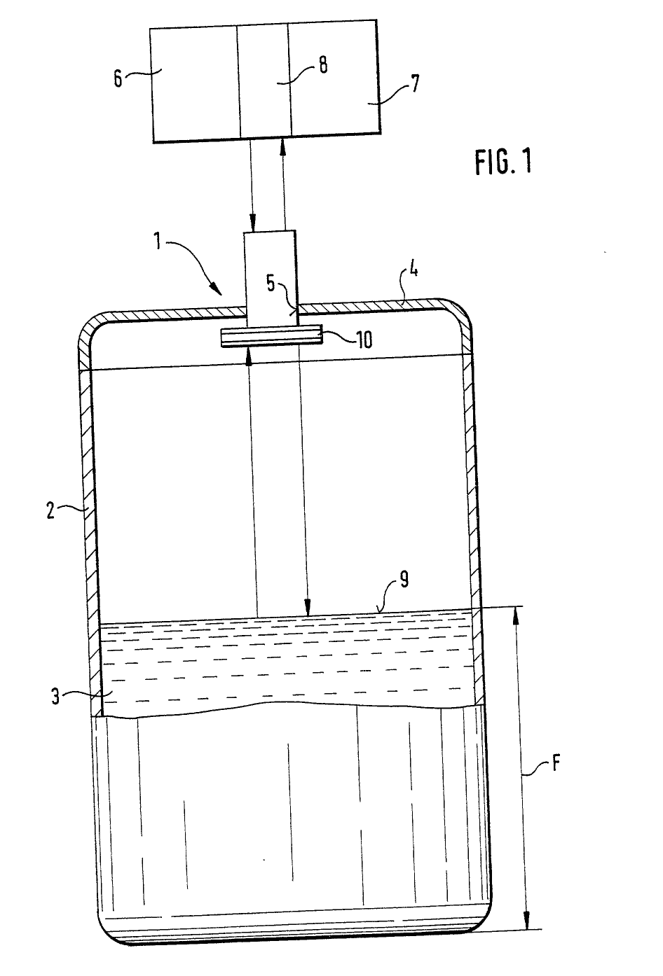

FIG. 1 shows a schematic of a device 1 according to the present invention. An antenna 10 for determining the filling level F of a filling material 3, which is located in a container 2, is mounted in an opening 5 in a lid 4 of the container 2. The antenna 10 is arranged in the opening 5 such that the measuring signals, which are generated in a signal-generating unit 6, strike the surface 9 of the filling level 3 essentially perpendicularly. The measuring signals reflected at the surface 9 are received by the antenna 10 and relayed from there via a transmitting/receiving switch 8 to a receiving/evaluating circuit 7. The receiving/evaluating circuit 7 uses the propagation time of the measuring signals to determine the filling level F of the filling material 3 in the container 2.

The principle of the design of a corresponding microwave measuring instrument is known from the prior art. Corresponding instruments are marketed and sold by the applicant's signal under the designation of Micropilot.

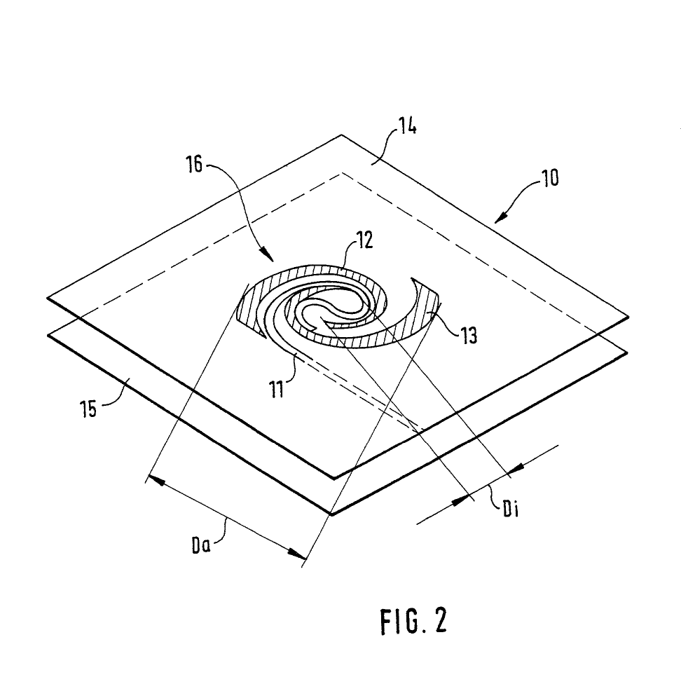

A plan view showing details of the antenna 10 according to the present invention is to be seen in FIG. 2. An antenna structure 16 is preferably applied to a dielectric substrate 14 using Microstrip Line Technology. The antenna structure 16 has two spiral arms 12, 13 with opposite senses of rotation. The frequency range of the measuring signals which are respectively emitted/received via one of the two spiral antennas 12 or 13 is defined essentially by the inside diameter Di, the outside diameter Da and the number n of the turns of the spiral arms 12, 13. It is therefore possible also to use the solution according to the present invention to create without difficulties antennas 10 which emit or receive measuring signals in two different frequency ranges for example at 6 GHz and 24 GHz.

The measuring signals coming from the signal-generating/transmitting units 6 are coupled in via a signal injector 11. A reflector coating 15 is provided on one side of the dielectric coating 14. This reflector coating 15 ensures that the measuring signals are emitted in the direction of the filling material 3.

In the claims:

1. A device for determining the filling level of a filling material in a container, the filing material defining a surface, comprising:
a signal-generating unit for generating measuring signals;
an evaluating circuit connected to said signal-generating unit;
an antenna connected to said signal-generating unit and said evaluating circuit, said antenna having at least one first dielectric substrate and an antenna structure arranged thereon, said antenna structure being at least one spiral antenna; and
a signal injector connected to said antenna structure, wherein:
said signal injector injects the measuring signals onto said antenna structure,
said antenna emitting the measuring signals from said signal injector in the direction of the surface of the filling material,
said evaluation circuit receiving the measured signals reflected at the surface of the filling material and received by said antenna and determines the filing level of the filling material in the container via the propagation time of the measuring signals.

2. The device as defined in claim 1, wherein the measuring signals are measuring pulses or FMCW signals.

3. The device as defined in claim 1, wherein said antenna structure comprises a logarithmic spiral antenna.

4. The device as defined in claim 1, wherein the dimensions of said antenna structure are coordinated such that measuring signals of a desired frequency range can be emitted and/or received.

5. The device as defined in claim 4, wherein said antenna structure has an inside diameter, an outside diameter and a given number of turns, and wherein the frequency range of the emitted and/or the received measuring signals is determined substantially by said inside diameter, said outside diameter and said number of turns.

6. The device as defined in claim 1, wherein said spiral antenna has at least one first spiral arm and a second spiral arm.

7. The device as defined in claim 1, wherein said spiral antenna is applied to said first dielectric substrate using stripline technology.

8. The device as defined in claim 1, wherein said antenna structure is produced from copper.

9. The device as defined in claim 1, further comprising:
a reflector layer arranged on the side of said at least one first dielectric substrate facing said filling material.
